(19) United States
(12) Patent Application Publication
(10) Pub. No.: US 2009/0210396 A1
(43) Pub. Date: Aug. 20, 2009

(54) Document management method, document management apparatus, and computer-readable medium storing a document management program product

(75) Inventor: Jun Satoh, Yokohama-shi (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/379,025

(22) Filed: Feb. 11, 2009

(30) Foreign Application Priority Data
Feb. 19, 2008 (JP) 2008-037636

(51) Int. Cl. G06F 17/30

(52) U.S. Cl. 707/3; 707/E17.014; 707/E17.008

(57) ABSTRACT

A document management apparatus includes a registration unit to register an electronic document together with property information, a document storage unit to store at least one electronic document registered by the registration unit in a database, a calculation unit to digitize a quantifiable feature of the electronic document, a retrieval unit to retrieve target electronic documents from the stored electronic documents based on a keyword, and a display unit to display a list of electronic documents and quantifiable features of the retrieved electronic documents.

### CROSS-REFERENCE TO RELATED APPLICATION

This application claims priority to Japanese Patent Application No. 2008-037636 filed on Feb. 19, 2008 in the Japan Patent Office, the entire contents of which are hereby incorporated by reference herein.

### BACKGROUND OF THE INVENTION

1. Field of the Invention

The present invention relates to a document management method, apparatus, and computer-readable medium having a document management program product to implement the document management method.

2. Discussion of the Background Art

A document management system generally includes a variety of retrieval functions to pick out a particular electronic document that a user desires from a large number of electronic documents registered in the document management system. One example of a retrieval function is a so-called keyword-search method, in which a keyword specified by a user is used to retrieve a particular electronic document. Another example is a method using relevancy of a document to a keyword or similarity between electronic documents. Using these methods, it is possible for a user to pick out a desired electronic document from a large number of such documents.

Most known document management methods for retrieving a document focus on content information of the electronic document. Accordingly, target electronic documents are retrieved based on a topic (keyword) that a user is interested in. However, great number of electronic documents may be retrieved with these methods, necessitating relatively lengthy checks of all the retrieved electronic documents.

To reduce the number of documents retrieved (and thus the time required to check through them), one known document management system employs a method using a so-called adaptation score to reduce the number of electronic documents retrieved. Specifically, the known document management system converts an adaptation of a registered electronic document to a numerical value that is an adaptation score, calculates an attribute score based on an attribute of the registered electronic document, and then calculates a composition score from the adaptation score and the attribute score. Using the composition score, a list of the electronic documents that a user wants to get is obtained and displayed with a predetermined number of the electronic documents, for example, in order of decreasing size of the composition score.

However, it may not be possible to retrieve with precision electronic documents that can be browsed from the list of registered electronic documents retrieved based simply on the content of the electronic document. Further, it may not possible to browse the retrieved electronic document depending on a browsing condition of the document management system. Specifically, when a user retrieves electronic documents using a keyword and browses the electronic document from a list of the retrieved electronic documents, the electronic document may not be displayed correctly depending on the browsing system.

Hardware factors also play a part in the retrieval outcome. For example, a personal computer (PC) generally can browse any electronic document including tables and drawings. However, a mobile terminal cannot display the tables and drawings correctly, or it takes too much time to display the electronic document that includes tables and drawings. For such mobile terminals, it is preferable to make a retrieval request only for a plain-text electronic document. If the user can obtain information on the length of each sentence in a document, or know whether or not a document includes a table or a drawing, it is then possible to obtain a much shorter list of relevant documents based on such information.

### SUMMARY OF THE INVENTION

This patent specification describes a document management apparatus that includes a registration unit to register an electronic document together with property information, a document storage unit to store the electronic documents registered by the registration unit in a database, a calculation unit to digitize a quantifiable feature of the electronic document, a retrieval unit to retrieve target electronic documents from the stored electronic documents based on a keyword, and a display unit to display a list of electronic documents and the quantifiable features of the retrieved electronic documents.

This patent specification further describes a document management method that includes the steps of registering electronic documents together with property information, storing the registered electronic documents in a database, digitizing a quantifiable feature of the electronic document, retrieving target electronic documents from the stored electronic documents based on a keyword, and displaying a list of electronic documents and the quantifiable features of the retrieved electronic documents.

Further, this patent specification describes a computer-readable medium that stores a computer program product stored on a computer-readable storage medium for, when run on a data processing apparatus, controlling document. The computer program product includes the steps of registering electronic document together with property information, storing the registered electronic documents in a database, digitizing a quantifiable feature of the electronic document, retrieving target electronic documents from the stored electronic documents based on a keyword, and displaying a list of electronic document and the quantifiable features of the retrieved electronic documents.

### BRIEF DESCRIPTION OF THE DRAWINGS

A more complete appreciation of the invention and many of the advantages thereof may be obtained as the same become better understood by reference to the following detailed description when considered in connection with the accompanying drawings, wherein:

FIG. 1 shows a configuration of a computer system used to implement a document management method according to an illustrative embodiment of the present invention;

FIG. 2 shows a document management system according to an illustrative embodiment; and

FIG. 3 is a flowchart showing a calculation process of calculating a quantifiable feature of an electronic document.

### DETAILED DESCRIPTION OF THE INVENTION

In describing embodiments illustrated in the drawings, specific terminology is employed for the purpose of clarity. However, the disclosure of this patent specification is not intended to be limited to the specific terminology so used, and it is to be understood that substitutions for each specific element can include any technical equivalents that operate in a similar manner and achieve a similar result.

Referring now to the drawings, wherein like reference numerals designate identical or corresponding parts throughout the several views, a description will now be given of embodiments of the present invention.

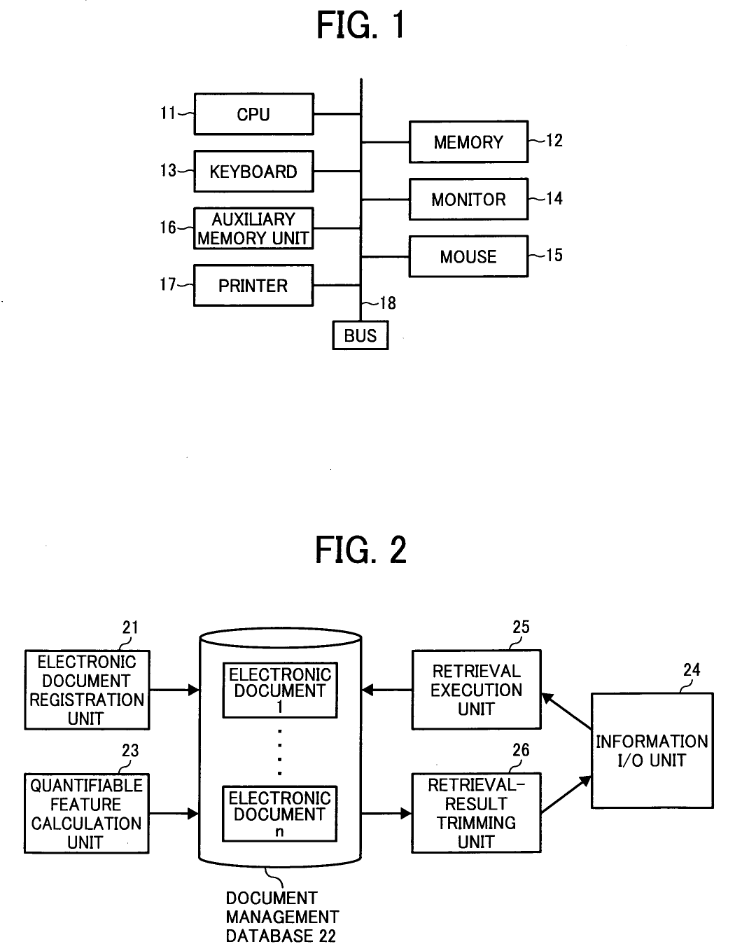

FIG. 1 shows a configuration of a computer system used to implement a document management method according to an embodiment of the present invention. The computer system includes a central processing unit (CPU) 11, a memory 12, an input unit (keyboard) 13, an image display unit (monitor) 14, a mouse 15, an auxiliary memory unit 16, and a bus 18 which interconnects the aforementioned units. The CPU 11 implements programs with data, both of which are stored in the memory 12. The monitor 14 displays instructions, images, etc. stored in the auxiliary memory unit 16. The auxiliary memory unit 16 includes storage media such as a floppy disk (registered trademark), a hard disk, etc. Further, it is possible to retrieve electronic documents using interface devices such as the keyboard 13 and the mouse 15. The mouse 15 is a pointing device to input data by tracing the data with a motion of so-called “mouse cursor” thereon. Further, it is possible to print a list and contents of the electronic documents retrieved.

### First Illustrative Embodiment

FIG. 2 shows a document management system according to a first illustrative embodiment. The document management system includes an electronic document registration unit 21, a document management database 22, a quantifiable feature calculation unit 23, an information input/output unit 24, a retrieval execution unit 25 and a retrieval-result trimming unit 26. Operation of the above-described system is described below.

First, an electronic document is registered. The electronic document registration unit 21 stores the electronic document in the document management database 22. Generally, attributes such as title of the electronic document are registered as well as the electronic document itself at the same time. Further, an identifier is determined to identify the electronic document in the document management database 22.

Next, the quantifiable feature calculation unit 23 calculates a quantifiable feature of the electronic document stored in the document management database 22. In the present embodiment, the quantifiable feature of the electronic document is a number of pages of the electronic document. Some electronic documents may contain the number of pages with a predetermined format that is stored in the document management 22 together with the electronic document, so that just the number of pages can be extracted without having to calculate the number of pages for such electronic document. The calculated or extracted quantifiable feature is then stored in the document management database 22 with the identifier that corresponds to the electronic document.

A method for retrieving target electronic documents from the registered electronic documents by a retrieval system will now be described.

First, a user specifies conditions such as a keyword and an attribute, each of which relates to the target electronic document through the information input/output unit 24. Based on the specified conditions, the retrieval execution unit 25 performs a retrieval operation to obtain an identifier for a corresponding group of electronic documents.

Subsequently, the retrieval-result trimming unit 26 obtains attribute values such as the title of the electronic document and a link to browse the electronic document from the document management database 22 using the identifier obtained in the retrieval operation. Further, the retrieval-result trimming unit 26 arranges the links and the electronic documents in the form of a list or table to display through the information input/output unit 24. At the same time, the number of pages of the electronic document that is the quantifiable feature may be displayed. Further, it is possible to display the links and the electronic documents by sorting them in ascending or descending order of the number of the pages as instructed by the user.

### Second Illustrative Embodiment

In a document with markup language as typified by HTML (Hypertext Markup Language), specification of chapters and paragraphs is described as a file format. Accordingly, the number of chapters and paragraphs can be obtained therefrom. In this second illustrative embodiment, for example, complexity of a configuration of the electronic document is defined by a following equation.

(number of chapters)+(number of paragraphs)×0.1

A value of the equation is then determined as a quantifiable feature of the electronic document. Unlike the number of pages, the value thus obtained is not defined in terms of a generalized, easy-to-understand concept. Accordingly, such value is difficult to understand when used directly as a criterion by which to judge or determine the relevance of a particular document. Therefore, the value is converted to a relative number that enables a user to quickly and easily grasp the relevance of the electronic document therefrom. Thus, for example, the largest value among the values for the registered electronic documents is converted to “100” so that the quantifiable feature of the electronic document can be ascertained more easily by the relative value of the electronic document in the present embodiment.

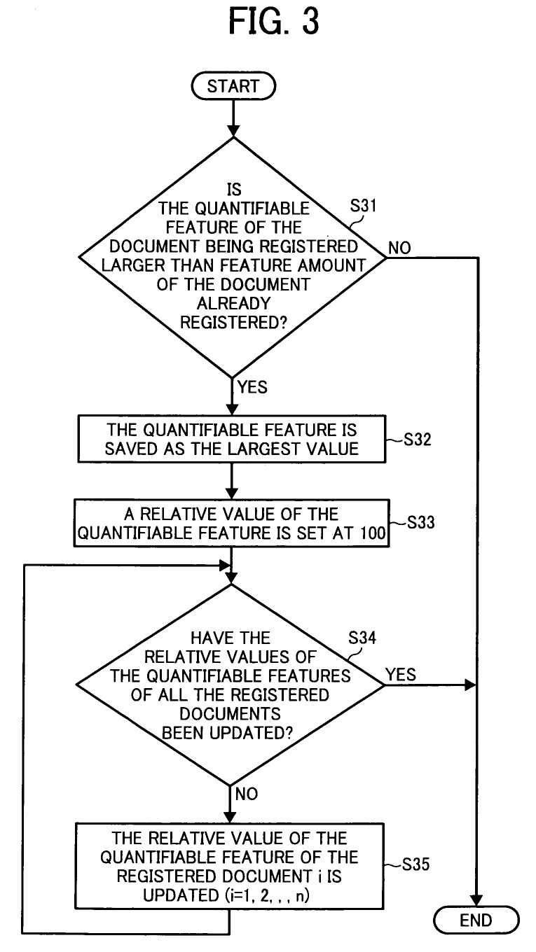

FIG. 3 is a flowchart showing a calculation process for calculating the quantifiable feature calculated by the quantifiable feature calculation unit 23 to obtain the relative value described above.

In the calculation process, first, it is determined whether or not a quantifiable feature of an electronic document being registered is larger than a quantifiable feature of an electronic document that is already registered (Step S31). If the quantifiable feature is smaller than the quantifiable feature of the electronic document that is already registered, the calculation process ends (Step S36). By contrast, if a quantifiable feature of the electronic document being registered is larger than the quantifiable feature of the electronic document that is already registered, the quantifiable feature of the electronic document being registered is saved as the largest value (Step S32), and the relative value of the quantifiable feature of the electronic document being registered is set at “100” (Step S33).

A check is then performed to determine whether or not the relative values of the quantifiable features of all the registered electronic documents have been updated based on calculated relative values (Step S34). If at least one electronic document remains not updated, that electronic document is updated (Step S35). This update process is repeated until all the electronic documents have been updated. When all the electronic documents are updated, the calculation process ends (Step S36).

Thus, the relative values of the electronic documents are calculated and the largest value is stored in the document management database 22 each time an electronic document is newly registered. Accordingly, it is necessary to store values for those quantifiable features that have not been converted to relative values obtained by the definition equation in the document management database 22.

### Third Illustrative Embodiment

In a third illustrative embodiment, whether an electronic document includes or does not include a drawing or figure is considered a quantifiable feature. The quantifiable feature may be a simple digital value, that is, “1” when the electronic document includes a figure and “0” when the electronic document does not include a figure. Alternatively, the quantifiable feature may be a relative value determined by the data amount.

### Fourth Illustrative Embodiment

In a fourth illustrative embodiment, whether a status of alt-attribute on image data is specified for electronic documents in HTML format is considered a quantifiable feature. Specifically, whether an electronic document includes or does not include a designation that specifies a value related to the alt-attribute of “img” tag is considered a quantifiable feature. With this arrangement, it is possible for a user who uses a document-read-software that utilizes voice-input to judge whether the electronic document includes information other than text data.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

According to the present invention, various kinds of misalignment due to the torsion of each region of the optical writing device can be adjusted to be incorporated in various kinds of the image forming apparatus having the optical writing device mounted thereon.

The above-described embodiments are illustrative and do not limit the present invention. Thus, numerous additional modifications and variations are possible in light of the above teachings. For example, elements at least one of features of different illustrative and exemplary embodiments herein may be combined with each other at least one of substituted for each other within the scope of this disclosure and appended claims. Further, features of components of the embodiments, such as the number, the position, and the shape, are not limited the embodiments and thus may be preferably set. It is therefore to be understood that within the scope of the appended claims, the disclosure of this patent specification may be practiced otherwise than as specifically described herein.

What is claimed is:

1. A document management apparatus, comprising:
a registration unit to register an electronic document together with document property information;
a document storage unit to store at least one electronic document registered by the registration unit in a database;
a calculation unit to digitize a quantifiable feature of the electronic document;
a retrieval unit to retrieve target electronic documents from the stored electronic documents based on a keyword; and
a display unit to display a list of electronic documents and the quantifiable feature of the retrieved electronic documents.

2. The document management apparatus according to claim 1, wherein the registration unit determines and registers an identifier to uniquely identify the electronic document together with the document property information.

3. The document management apparatus according to claim 1, wherein the calculation unit calculates the quantifiable feature of the electronic document based on a definitional equation stored in the database.

4. The document management apparatus according to claim 1, wherein the calculation unit calculates a quantifiable feature having mixed criteria created by combining more than one quantifiable feature.

5. The document management apparatus according to claim 1, wherein the display unit displays the electronic documents by arranging the electronic documents in a display order determined by one or more specified quantifiable features.

6. The document management apparatus according to claim 1, wherein the display unit displays content of an electronic document specified by a user from the list of electronic documents.

7. A document management method, comprising the steps of:
registering an electronic document together with document property information;
storing at least one registered electronic document in a database;
digitizing a quantifiable feature of the electronic document;
retrieving target electronic documents from the electronic documents stored in the database based on a keyword; and
displaying a list of electronic documents and quantifiable features of the retrieved electronic documents.

8. The document management method of claim 7, wherein an identifier is determined and registered to uniquely identify a particular electronic document together with the property information.

9. The document management method of claim 7, wherein the quantifiable feature of the electronic document is calculated based on a definitional equation stored in the database.

10. The document management method of claim 7, wherein a quantifiable feature having mixed criteria created by combining more than one quantifiable feature is calculated.

11. The document management method of claim 7, wherein the electronic documents are displayed by arranging the electronic documents in a display order by one or more specified quantifiable features.

12. The document management method of claim 7, wherein content of an electronic document specified by a user from the list of electronic documents is displayed.

13. A computer-readable medium storing a computer program product that, when run on a data processing apparatus, executes a document management method that manages documents,
the document management method comprising the steps of:
registering an electronic document together with document property information;
storing at least one registered electronic document in a database;
digitizing a quantifiable feature of the electronic document;
retrieving target electronic documents from the electronic documents stored in the database based on a keyword; and
displaying a list of electronic documents and quantifiable features of the retrieved electronic documents.
